(19) United States
(12) Patent Application Publication
(10) Pub. No.: US 2021/0140139 A1
(43) Pub. Date: May 13, 2021

(54) WORK VEHICLE

(71) Applicant: KOMATSU LTD., Tokyo (JP)

(72) Inventors: Nobuo MATSUYAMA, Minato-ku, Tokyo (JP); Shintaro KOBAYASHI, Minato-ku, Tokyo (JP)

(21) Appl. No.: 16/497,663

(22) PCT Filed: Sep. 10, 2018
(86) PCT No.: PCT/JP2018/033501

§ 371 Date: Sep. 25, 2019

(30) Foreign Application Priority Data
Sep. 21, 2017 (JP) 2017-180826

(51) Int. Cl. E02F 3/76; B60K 6/24; B60K 6/26; B60K 17/22; B60K 17/16; E02F 3/84; E02F 9/02; E02F 9/08; E02F 9/22; B60K 6/00

(52) U.S. Cl. CPC E02F 3/764; B60K 6/24; B60K 6/26; B60K 17/22; B60K 17/16; E02F 3/844; B60Y 2200/92; E02F 9/0841; E02F 9/22; B60K 6/00; B60Y 2200/41; B60Y 2400/80; E02F 9/02

(57) ABSTRACT

A work vehicle includes a rear frame, a front frame rotatably attached to the rear frame, a work implement attached to the front frame, a motor disposed on the front frame, a differential device connected to the motor, and a drive shaft connected to the differential device. The motor is disposed in front of the work implement.

### CROSS-REFERENCE TO RELATED APPLICATIONS

This application is a U.S. National stage application of International Application No. PCT/JP2018/033501, filed on Sep. 10, 2018. This U.S. National stage application claims priority under 35 U.S.C. § 119(a) to Japanese Patent Application No. 2017-180826, flied in Japan on Sep. 21, 2017, the entire contents of which are hereby incorporated herein by reference.

### BACKGROUND

### Field of the Invention

The present invention relates to a work vehicle.

### Background Information

Conventionally, there is known an all-wheel drive type motor grader provided with a rear wheel drive device for driving the left and right rear wheels, and a front wheel drive device for driving the left and right front wheels. In U.S. Pat. No. 6,491,600, a front wheel drive device is proposed in which the output of an engine is transmitted to two pumps and the front wheel drive device causes the respective left and right front wheels to be driven by two motors that rotate with hydraulic fluid supplied from the two pumps. The two motors are disposed inside the respective left and right front wheels.

### SUMMARY

However, because it is necessary to provide two pumps for driving the two motors in the front wheel drive device described in U.S. Pat. No. 6,491,600, the in-vehicle layout becomes complicated.

In consideration of the above situation, an object of the present invention is to provide a work vehicle with a simplified front wheel drive device.

A work vehicle according to the present invention has a rear frame, a front frame rotatably attached to the rear frame, a work implement attached to the front frame, a motor disposed on the front frame, a differential device connected to the motor, and a drive shaft connected to the differential device. The motor is disposed in front of the work implement.

According to the present invention, there can be provided a work vehicle with a simplified front wheel drive device.

### BRIEF DESCRIPTION OF THE DRAWINGS

FIG. 1 is a side view of a motor grader.

FIG. 2 is a top view of the motor grader.

FIG. 3 is a sectional view A-A of FIG. 2.

FIG. 4 is a top view illustrating a configuration of a right front wheel supporting mechanism.

FIG. 5 is a front view illustrating a configuration of the right front wheel supporting mechanism.

FIG. 6 is a block diagram illustrating a configuration of the front wheel drive device of the motor grader.

### DETAILED DESCRIPTION OF EMBODIMENT(S)

### (Overall Configuration of Motor Grader 1)

FIG. 1 is a side view of a motor grader 1. FIG. 2 is a top view of the motor grader 1. FIG. 3 is cross-sectional view along line A-A in FIG. 2. In the following discussion, “up,” “down,” “left,” “right,” “front,” and “back” are terms based on the perspective of an operator seated in the operator's seat.

The motor grader 1 is an all-wheel drive vehicle in which all the wheels are driven. The motor grader 1 is provided with a frame 10, left and right front wheels 20 and 21, two left and right rear wheels 30, 31, 32 and 33 on either side, a work implement 40, a cab 50, an engine 60, a hydraulic pump 70, a motor 80, a differential device 90, and left and right front wheel supporting mechanisms 100 and 101.

The frame 102 is configured by a front frame 11 and a rear frame 12. The front frame 11 is disposed in front of the rear frame 12. The front frame 11 is coupled to the rear frame 12. The front frame 11 is able to rotate left and right with respect to the rear frame 12. The front frame 11 is supported by the left and right front wheels 20 and 21. The front frame 11 supports the work implement 40. The front frame 11 has a beam part 11a that extends in the front-back direction. The motor 80 and the differential device 90 are disposed at the front end of the beam part 11a. The rear frame 12 is supported by the left and right rear wheels 30, 31, 32 and 33. The cab 50, the engine 60, and the hydraulic pump 70 are disposed on the rear frame 12.

The work implement 40 is attached to the front frame 11. The work implement 40 is disposed below the front frame 11. The work implement 40 is disposed between the left and right front wheels 20 and 21 and the left and right rear wheels 30, 31, 32 and 33 in the front-back direction. The work implement 40 is provided with a drawbar 41, a blade 42, a blade turning device 43, a lifter bracket 44, left and right lift cylinders 45 and 46, and a shift cylinder 47.

The drawbar 41 is coupled to the front end part of the front frame 11 in a manner that allows swinging up and down and left and right. The blade 42 is supported by the blade turning device 43. The blade turning device 43 is attached to a rear end part of the drawbar 41. The blade turning device 43 has a circle 43a and a circle rotator 43b. The circle 43a is rotatably supported at the rear end part of the drawbar 41. The circle 43a supports the blade 42. The circle rotator 43b drives and rotates the circle 43a with hydraulic pressure.

The lifter bracket 44 is fixed to the frame 10 (specifically, the front frame 11). The left and right lift cylinders 45 and 46 and the shift cylinder 47 are coupled to the lifter bracket 44.

The left and right lift cylinders 45 and 46 are coupled to the drawbar 41 and to the lifter bracket 44. The left and right lift cylinders 45 and 46 extend and contract thereby causing the drawbar 41 to swing up and down. The shift cylinder 47 is coupled to the drawbar 41 and to the lifter bracket 44. The shift cylinder 47 extends and contracts thereby causing the drawbar 41 to swing left and right.

The cab 50 is mounted on the frame 10. The operator's seat and operating devices and the like are disposed in the cab 50. The engine 60 is mounted on the rear frame 12. An unillustrated rear wheel drive device (a torque converter, a transmission, a final drive gear, or a tandem device, etc.) is connected to the engine 60, and the left and right rear wheels 30, 31, 32 and 33 are driven by the rear wheel drive device. The hydraulic pump 70 is connected to the engine 60. The hydraulic pump 70 is driven by the engine 60. The hydraulic pump 70 supplies hydraulic fluid to the motor 80. For example, a skew plate type or an inclined shaft type of hydraulic pump may be used as the hydraulic pump 70.

The motor 80 is contained inside the front end part of the front frame 11 as illustrated in FIG. 3. The motor 80 is fixed onto an axle support 95 that contains the differential device 90. However, the motor 80 may be disposed outside of the front frame 11 and may be disposed in a position away from the axle support 95.

The motor 80 is connected to the hydraulic pump 70 by means of unillustrated hydraulic fluid piping. The motor 80 is a hydraulic motor that drives due to hydraulic fluid supplied by the hydraulic pump 70. For example, a radial piston type hydraulic motor may be used as the motor 80, but the present invention is not limited in this way.

When the motor grader 1 turns to the left or right, the turning radius of the front wheels 20 and 21 is greater than the turning radius of the rear wheels 30, 31, 32 and 33 due to the turning radius differential. Therefore, the front wheels 20 and 21 need to rotate faster than the rear wheels 30, 31, 32 and 33. Accordingly, the motor 80 is provided in order to cause the motor grader 1 to turn smoothly by rotating the front wheels 20 and 21 faster than the rear wheels 30, 31, 32 and 33.

The motor 80 is disposed in front of the work implement 40 as illustrated in FIGS. 1 and 2. Specifically, the motor 80 is disposed further to the front than the drawbar 41, the blade 42, the blade turning device 43, the lifter bracket 44, the left and right lift cylinders 45 and 46, and the shift cylinder 47 that constitute the work implement 40. The motor 80 is disposed so that a portion thereof overlaps the beam part 11a of the front frame 11 as illustrated in FIG. 2.

The differential device 90 is contained inside the axle support 95 as illustrated in FIG. 3. The axle support 95 is attached to the front frame 11 in a manner that allows swinging to the left and right relative to the differential center of the differential device 90. The differential device 90 is drive-coupled to the motor 80. The differential device 90 is driven by the motor 80.

When the motor grader 1 turns to the left or right, the turning radius of the outside wheel is greater than the turning radius of the inside wheel among the front wheels 20 and 21 due to the turning radius differential, and, therefore, the outside wheel needs to rotate faster than the inside wheel. Accordingly, the differential device 90 is provided in order to cause the motor grader 1 to turn smoothly by rotating the outside wheel faster than the inside wheel.

The differential device 90 is disposed in front of the work implement 40 as illustrated in FIGS. 1 and 2. Specifically, the differential device 90 is disposed further to the front than the drawbar 41, the blade 42, the blade turning device 43, the lifter bracket 44, the left and right lift cylinders 45 and 46, and the shift cylinder 47 that constitute the work implement 40. The differential device 90 is disposed so that a portion thereof overlaps the beam part 11a of the front frame 11 as illustrated in FIG. 2.

In the present embodiment, the differential device 90 is disposed below the motor 80, but the present invention is not limited in this way. The differential device 90 may be disposed in a position that is the same as the motor 80 in the up-down direction, or may be disposed above the motor 80. The differential device 90 may be disposed further toward the front or may be disposed further toward the rear than the motor 80 in the front-back direction.

The left and right front wheel supporting mechanisms 100 and 101 are respectively connected to the left and right of the axle support 95. The respective configurations of the left and right front wheel supporting mechanisms 100 and 101 are the same and the configuration of the left front wheel supporting mechanism 100 will be mainly explained.

FIG. 4 is a top view illustrating a configuration of the left front wheel supporting mechanism 100. FIG. 5 is a front view illustrating the configuration of the left front wheel supporting mechanism 100. A cross-section of the internal structure is partially illustrated in FIG. 5.

The left front wheel supporting mechanism 100 has a left drive shaft 100a, a left constant-velocity joint 100b, a left steering cylinder 100c, a tie rod 100d, a left leaning cylinder 100e, a left lean housing 100h, and a left hub carrier 100i.

The left drive shaft 100a extends from the differential device 90 toward a left wheel 20a. The left drive shaft 100a is coupled to the differential device 90 and the left constant-velocity joint 100b. The left drive shaft 100a is inserted into the axle support 95. The side of the left drive shaft 100a on the opposite side from the differential device 90 is coupled to a right drive shaft 101a.

The left constant-velocity joint 100b is disposed inside the left hub carrier 100i. The left constant-velocity joint 100b has a coupling shaft 100f. The coupling shaft 100f is coupled to a wheel hub 100g. The wheel hub 100g is disposed inside the left wheel 20a to which the left front wheel 20 is attached. The left constant-velocity joint 100b is able to swing with respect to the left drive shaft 100a around a steering axis AX1 that is parallel to the up-down direction. The left constant-velocity joint 100b is able to swing with respect to the left drive shaft 100a around a leaning axis AX2 that is parallel to the front-back direction.

The left steering cylinder 100c is coupled to the front frame 11 and the left hub carrier 100i. The left hub carrier 100i swings around the steering axis AX1 due to the extension and contraction of the left steering cylinder 100c. Consequently, the steering of the left front wheel 20 is performed. The tie rod 100d is coupled to the left hub carrier 100i and an unillustrated right hub carrier.

The left leaning cylinder 100e is coupled to the axle support 95 and the left lean housing 100h. The left lean housing 100h swings around the leaning axis AX2 due to the extension and contraction of the left leaning cylinder 100e. Consequently, the leaning of the left front wheel 20 is performed.

### (Configuration of Front Wheel Drive Device 2)

FIG. 6 is a block diagram illustrating a configuration of the front wheel drive device 2 of the motor grader 1.

The front wheel drive device 2 is provided with a controller 120 for controlling the pump 70 and the motor 80. The controller 120 adjusts the rotation speed of the motor 80 by adjusting the amount of hydraulic fluid supplied to the motor 80 from the pump 70.

The controller 120 adjusts the amount of hydraulic fluid supplied to the motor 80 from the pump 70 on the basis of, for example, the turning radius of the motor grader 1, the rotation speeds of the left and right rear wheels 30, 31, 32 and 33, or the rotation speed of the engine 60. Specifically, when the motor grader 1 turns to the left or right, the controller 120 causes the front wheels 20 and 21 to rotate faster than the rear wheels 30, 31, 32 and 33 by increasing the amount of hydraulic fluid supplied from the pump 70 to the motor 80.

The rotational force of the motor 80 is transmitted through the differential device 90 to the left and right drive shafts 100 and 101. Specifically, when the motor grader 1 turns to the left or right, the outer wheel is rotated faster than the inner wheel due to the differential device 90 adjusting the respective rotation speeds of the left and right drive shafts

### (Characteristics)

In the motor grader according to the present embodiment, only one motor 80 may be provided because the turning radius differential of the left and right front wheels 20 and 21 is adjusted by the differential device 90. In addition, the motor 80 can be disposed near the differential device 90 because the motor 80 is disposed in front of the work implement 40. Therefore, the configuration of the front wheel drive device 2 is simplified.

Moreover, because the motor 80 is disposed on the front frame 11, damage to the hydraulic piping when struck by earth and sand or the like can be limited because exposure of the hydraulic piping connected from the pump 70 to the motor 80 can be limited.

### Other Embodiments

While the motor 80 in the above embodiment is a hydraulic motor that drives due to hydraulic fluid supplied by the hydraulic pump 70, the present invention is not limited in this way. An electric motor may be used as the motor 80. In this case, the motor grader 1 may be provided with a generator that is driven by the engine and that supplies electrical power to the motor 80.

While a motor grader has been discussed as an example of the work vehicle to which the front wheel drive device as in the present invention is applied, the front wheel drive device as in the present invention may be widely applicable to an all-wheel drive type of work vehicle.

1. A work vehicle comprising:
a rear frame;
a front frame rotatably attached to the rear frame;
a work implement attached to the front frame;
a motor disposed on the front frame;
a differential device connected to the motor; and
a drive shaft connected to the differential device,
the motor being disposed in front of the work implement.

2. The work vehicle according to claim 1, wherein
the differential device is disposed in front of the work implement.

3. The work vehicle according to claim 1, further comprising:
rear wheels supporting the rear frame; and
front wheels supporting the front frame,
the work implement being disposed between the rear wheels and the front wheels.

4. The work vehicle according to claim 3, wherein
the work implement has
a drawbar coupled to the front frame in a manner that allows swinging up and down, and
a lift cylinder that causes the drawbar to swing up and down, and
the motor is disposed in front of the lift cylinder.

5. The work vehicle according to claim 4, wherein
the work implement has a blade turning device that is rotatably supported by the drawbar, and
the motor is disposed in front of the blade turning device.

6. The work vehicle according to claim 5, wherein
the work implement has a blade that is supported by the blade turning device, and
the motor is disposed in front of the blade.

7. The work vehicle according to claim 1, wherein
the front frame has a beam part and
the motor is disposed at a front end part of the beam part.

8. The work vehicle according to claim 1, wherein
the motor is disposed above the differential device.

9. The work vehicle according to claim 7, wherein
at least a portion of the motor and at least a portion of the differential device overlap the beam part when viewed from a top view.

10. The work vehicle according to claim 1, further comprising:
an engine; and
a hydraulic pump driven by the engine,
the motor being a hydraulic motor that drives due to hydraulic fluid supplied by the hydraulic pump.

11. The work vehicle according to claim 1, further comprising:
an engine; and
a generator driven by engine,
the motor being an electric motor that drives due to electrical power supplied by the generator.

12. The work vehicle according to claim 1, wherein
the work vehicle is a motor grader.
